(19) United States
(12) Patent Application Publication
(10) Pub. No.: US 2020/0243830 A1
(43) Pub. Date: Jul. 30, 2020

(54) BATTERY SYSTEM AND BUSBAR USED IN SAME BATTERY SYSTEM

(71) Applicant: SANYO Electric Co., Ltd., Daito-shi, Osaka (JP)

(72) Inventors: Tomomi Tanaka, Hyogo (JP); Go Yamashiro, Hyogo (JP); Takashi Yoshida, Hyogo (JP); Kazuaki Endo, Osaka (JP)

(73) Assignee: SANYO Electric Co., Ltd., Daito-shi, Osaka (JP)

(21) Appl. No.: 16/486,372

(22) PCT Filed: Mar. 15, 2018
(86) PCT No.: PCT/JP2018/010116

§ 371 Date: Aug. 15, 2019

(30) Foreign Application Priority Data
Mar. 17, 2017 (JP) 2017-053499

(51) Int. Cl. H01M 2/20; H01M 2/10; H01M 2/34; H01M 2/30; H01M 10/48; H01R 11/28

(52) U.S. Cl. CPC H01M 2/206; H01M 2/1077; H01R 11/288; H01M 2/30; H01M 10/482; H01M 2/34

(57) ABSTRACT

A battery system includes a battery stack formed by stacking a plurality of battery cells, a bus bar coupling electrode terminals of the battery cells, a lead wire electrically coupled to the bus bar, and a voltage detection circuit configured to detect a voltage of each of the battery cells via the lead wire. The bus bar includes a bus bar main body including terminal coupling parts respectively coupled with the electrode terminals, and a lead wire fixing part fixed with the lead wire. The bus bar further includes, on a first surface, a coupling region electrically coupled with the lead wire, and, away from a coupling region, on the lead wire fixing part, a lock connection part locking and connecting the lead wire. The lock connection part includes a through part passing through the lead wire fixing part.

### TECHNICAL FIELD

The present invention relates to battery systems each including a plurality of battery cells stacked and coupled with each other via a bus bar, and, in particular, relates to a battery system including a circuit configured to detect a voltage of each of battery cells, and relates to as well a bus bar used in the battery system.

### BACKGROUND ART

To increase an output of a power source device, a plurality of battery cells are coupled in series to increase a voltage. In the power source device, the battery cells connected in series are charged at an identical charge current, as well as the battery cells connected in series discharge electricity at an identical current. Accordingly, in a case where all battery cells each have exactly identical characteristics, neither a battery voltage nor a remaining capacity would be likely to be unbalanced. However, in reality, such batteries each having exactly identical characteristics cannot be manufactured. Unbalance among battery cells leads to unbalance in voltage or remaining capacity through repetitive charging and discharging. Furthermore, unbalance in battery voltage leads to over-charging or over-discharging in a certain battery cell. A power source device has been developed that is configured to detect a voltage of each of battery cells to prevent over-charging or over-discharging from occurring in a battery cell. (See PTL 1)

### CITATION LIST

### Patent Literature

PTL 1: Unexamined Japanese Patent Publication No. 2015-187909

### SUMMARY OF THE INVENTION

### Technical Problem

The power source device includes a voltage detection circuit configured to detect a voltage of each of the battery cells. The voltage detection circuit detects a voltage of each of the battery cells to control charging and discharging currents to prevent over-charging or over-discharging from occurring in each of the battery cells. As illustrated in FIG. 21, the voltage detection circuit is coupled, via lead wire 108 serving as a voltage detection line, to bus bar 103 connecting electrode terminals 102 of the battery cells. The voltage detection circuit, where lead wire 108 coupled to an input side is coupled to bus bar 103, detects a voltage of each of the battery cell via lead wire 108 and bus bar 103. In the power source device, to securely couple lead wire 108 to bus bar 103, voltage detection terminal 104 is fixed to bus bar 103. Voltage detection terminal 104 is fixed to a surface of a copper plate that is a metal plate constituting the bus bar, through welding or soldering, for example.

However, in such a case, for example, the wire would move up or down due to vibration or the like, and the wire would be also caught and pulled during a work. As a result, peel force (=separation force) would likely to cause a joining portion between the lead wire and the bus bar to come off. If the joining part between the lead wire and the bus bar comes off, it is erroneously detected that the battery loses its voltage. If such an event occurs in an electric vehicle, the vehicle cannot be started.

Instead of welding or soldering, such a method that fixation is implemented through tightening of screws has been studied. In such a method, however, a material cost and human hours increase, preventing manufacturing from taking place at a lower cost. In fixation through tightening of screws, the screws would be likely to be loosed as time passes by, for example, causing the fixation to lose its long-term reliability.

In view of the problems described above, the present invention has an object of providing a battery system and a bus bar used in the battery system, where a voltage detection lead wire is stably coupled to the bus bar at a low cost, a coupling portion between the lead wire and the bus bar is prevented from peeling off, and a voltage of each of battery cells can be stably detected for a long period of time.

### Solution to Problem and Advantageous Effects of Invention

A battery system according to an exemplary embodiment of the present invention includes a battery stack 10 formed by stacking a plurality of battery cells 1 each including positive and negative electrode terminals 2, a bus bar 3 coupling with each other the electrode terminals 2 of the plurality of battery cells 1, a voltage detection lead wire 8 electrically coupled to the bus bar 3, and a voltage detection circuit 9 configured to detect a voltage of each of the battery cells 1 via the lead wire 8. The bus bar 3 includes a bus bar main body 3A including a plurality of terminal coupling parts 4 respectively coupled with the electrode terminals 2, and a lead wire fixing part 3B integrally connected to the bus bar main body 3A and fixed with the lead wire 8. The bus bar 3 further includes, on a first surface 31, a coupling region 5 electrically coupled with the lead wire 8, and, away from the coupling region 5, on the lead wire fixing part 3B, a lock connection part 6 locking and connecting the lead wire 8. The lock connection part 6 has a through part 7 passing through the lead wire fixing part 3B. In the through part 7, the lead wire 8 is disposed at least from a second surface 32 opposite to the first surface 31 to the first surface 31 of the bus bar 3.

With the configuration described above, the voltage detection lead wire electrically coupled to the bus bar can be securely fixed to the bus bar without allowing the lead wire from coming off the bus bar. A reason is that the lock connection part configured to lock and connect the lead wire is provided on the lead wire fixing part integrally connected to the bus bar main body, the lock connection part is provided with the through part passing through the lead wire fixing part, and, on the through part, the lead wire is disposed at least from the second surface to the first surface of the bus bar.

With a battery system according to another exemplary embodiment of the present invention, the through part 7 may include cutouts 7A, 7B obtained by cutting out parts of the lead wire fixing part 3B.

With the configuration described above, without inserting a voltage detection lead wire into the through part from its tip, its intermediate portion can be inserted from open regions, advantageously improving workability when coupling the lead wire.

With a battery system according to still another exemplary embodiment of the present invention, the through part 7 may include a plurality of columns of the slit-shaped cutouts 7A, 7B.

With the configuration described above, allowing the lead wire to pass through the plurality of columns of slit-shaped cutouts can increase a number of times the lead wire is disposed across the first surface and the second surface of the bus bar, further stably fixing the lead wire onto the lead wire fixing part.

With a battery system according to still another exemplary embodiment of the present invention, the plurality of columns of the slit-shaped cutouts 7A, 7B can be provided on side surfaces facing each other of the lead wire fixing part 3B.

With a battery system according to still another exemplary embodiment of the present invention, the through part 7 can have projections 12 projecting to respectively reduce opening areas of cutouts 7C, 7D.

With the configuration described above, the projection parts can prevent such an event that the lead wire comes off the opening parts being open on the cutouts.

With a battery system according to still another exemplary embodiment of the present invention, the bus bar main body 3A may have a flat plate shape, and the lead wire fixing part 3B may serve as a projection piece projecting from the bus bar main body 3A.

With a battery system according to still another exemplary embodiment of the present invention, the lead wire 8 may include a core wire 8a having conductivity, and a coating part 8b obtained by allowing the core wire 8a to undergo insulating coating, and the lead wire 8 can be locked onto lock connection part 6 via coating part 8b.

With a battery system according to still another exemplary embodiment of the present invention, the bus bar main body 3A and the lead wire 8 may be made of metals different in kind from each other.

With the configuration described above, performing welding onto a coupling region via the through part of the lock connection part, prevents stress from occurring in the peel direction, improving reliability in mechanical strength, in a problem that an intermetallic compound is generated through welding of the metals different in kind from each other and stiffness lowers in a peel direction.

With a battery system according to still another exemplary embodiment of the present invention, the bus bar main body 3A may be made of aluminum.

With the configuration described above, the lead wire can be stably coupled to the bus bar made of aluminum.

With a battery system according to still another exemplary embodiment of the present invention, the coupling region 5 may serve as a region coupling, through welding, the lead wire 8 made of copper.

With the configuration described above, a voltage detection terminal can be stably coupled to the bus bar made of aluminum.

A bus bar according to an exemplary embodiment of the present invention is a bus bar for electrically coupling with each other electrode terminals 2 of battery cells 1, and includes a bus bar main body 3A including a plurality of terminal coupling parts 4 respectively configured to be coupled with the electrode terminals 2, and a lead wire fixing part 3B configured to be integrally connected to the bus bar main body 3A and fixed with a voltage detection lead wire 8. The bus bar further includes, on a first surface 31, a coupling region 5 configured to be electrically coupled with the lead wire 8, and, away from a coupling region 5, on the lead wire fixing part 3B, a lock connection part 6 configured to lock and connect the lead wire 8. The lock connection part 6 is provided with a through part 7 capable of disposing the lead wire 8 from a second surface 32 opposite to the first surface 31 to the first surface 31 of the bus bar 3, and that passes through the lead wire fixing part 3B.

### BRIEF DESCRIPTION OF DRAWINGS

FIG. 1 is a schematic perspective view of a battery system according to an exemplary embodiment of the present invention.

FIG. 2 is an exploded perspective view of the battery system illustrated in FIG. 1.

FIG. 3 is a schematic plan view of the battery system illustrated in FIG. 1.

FIG. 4 is an enlarged perspective view illustrating a connection structure between a bus bar and a voltage detection line, according to a first exemplary embodiment.

FIG. 5 is a plan view of the bus bar and the voltage detection line illustrated in FIG. 4.

FIG. 6 is a side view of the bus bar and the voltage detection line illustrated in FIG. 5.

FIG. 7 is a plan view illustrating a connection structure between a bus bar and a voltage detection line, according to a second exemplary embodiment.

FIG. 8 is a perspective view illustrating a connection structure between a bus bar and a voltage detection line, according to a third exemplary embodiment.

FIG. 9 is a perspective view illustrating a connection structure between a bus bar and a voltage detection line, according to a fourth exemplary embodiment.

FIG. 10 is a perspective view illustrating another example of the connection structure between the bus bar and the voltage detection line, according to the fourth exemplary embodiment.

FIG. 11 is a perspective view illustrating a connection structure between a bus bar and a voltage detection line, according to a fifth exemplary embodiment.

FIG. 12 is a perspective view illustrating a connection structure between a bus bar and a voltage detection line, according to a sixth exemplary embodiment.

FIG. 13 is a perspective view illustrating a connection structure between a bus bar and a voltage detection line, according to a fifth exemplary embodiment.

FIG. 14 is a plan view of the bus bar and the voltage detection line illustrated in FIG. 13.

FIG. 15 is a cross-sectional view, taken along line XV-XV, of the bus bar and the voltage detection line illustrated in FIG. 14.

FIG. 16 is a perspective view illustrating a connection structure between a bus bar and a voltage detection line, according to a seventh exemplary embodiment.

FIG. 17 is a vertical cross-sectional view of a battery system including the bus bar illustrated in FIG. 16.

FIG. 18 is a block diagram illustrating an example where a power source device is mounted on a hybrid vehicle driven by both an engine and a motor.

FIG. 19 is a block diagram illustrating an example where a power source device is mounted on an electric vehicle driven by only a motor.

FIG. 20 is a block diagram illustrating an example of application of a power source device for a power storage purpose.

FIG. 21 is a perspective view of a conventional bus bar including a voltage detection terminal.

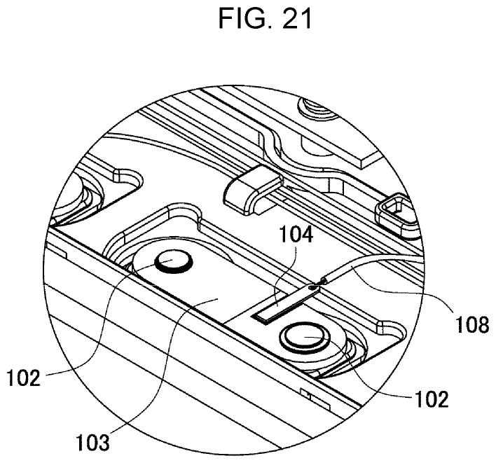

### DESCRIPTION OF EMBODIMENTS

Exemplary embodiments of the present invention will be described below with reference to the drawings. However, the exemplary embodiments described below show only an example for embodying the technical idea of the present invention, and the present invention is not limited to the following. Further, in the present description, members shown in the scope of claims are not limited to the members of the exemplary embodiments. In particular, it is not intended to limit the sizes, materials, and shapes of components and relative arrangement between the components, which are described in the exemplary embodiments, to the scope of the present invention unless otherwise specified. The sizes and the like are mere explanation examples. However, the sizes and the positional relation of the components in each drawing are exaggerated for clearing the explanation in some cases. Furthermore, in the following description, the same names or the same reference marks denote the same components or the same types of components, and detailed description is therefore appropriately omitted. Regarding the elements constituting the present invention, a plurality of elements may be formed of the same component, and one component may serve as the plurality of elements. To the contrary, the function of one component may be shared by the plurality of components.

The battery system according to the present invention, described above, is used for various purposes, such as a power source mounted on a powered vehicle such as a hybrid vehicle or an electric vehicle and used for supplying power to a traction motor, a power source that stores power generated by natural energy such as photovoltaic power generation or wind-power generation, or a power source that stores night power, and are particularly used as a power source preferable for large power and large current.

### First Exemplary Embodiment

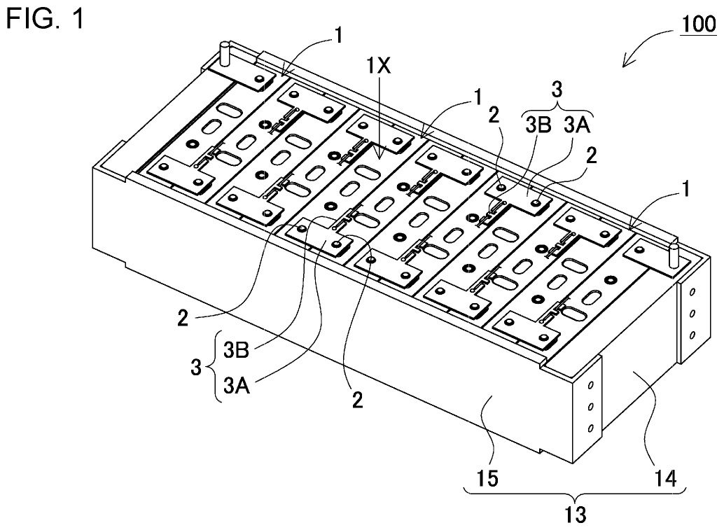

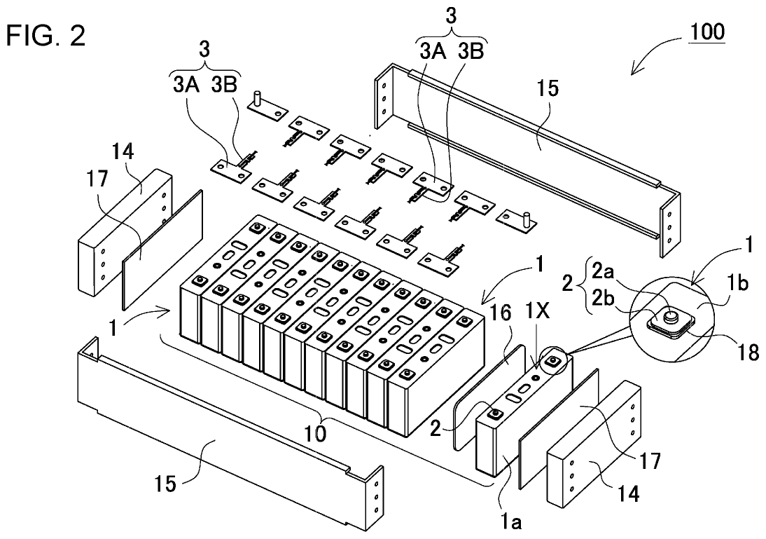

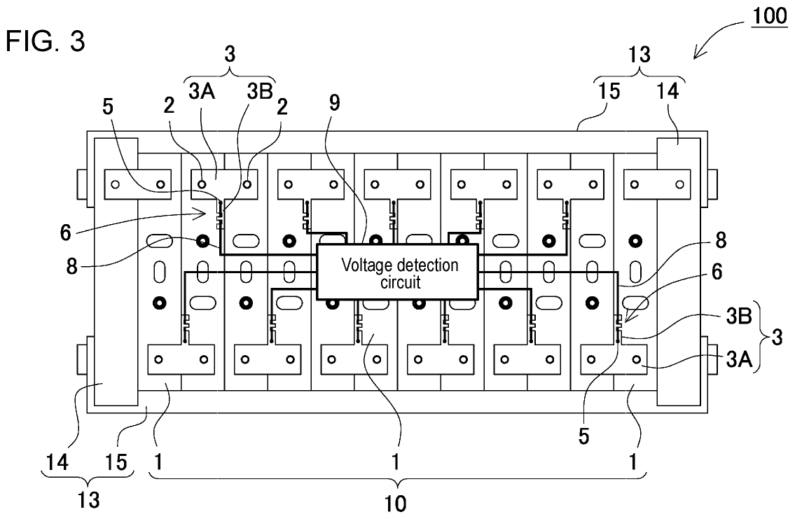

FIG. 1 is a perspective view, FIG. 2 is an exploded perspective view, and FIG. 3 is a schematic plan view of battery system 100 according to a first exemplary embodiment of the present invention. Battery system 100 illustrated in FIGS. 1 to 3 includes battery stack 10 formed by stacking a plurality of battery cells 1 each including positive and negative electrode terminals 2, bus bars 3 each coupling with each other electrode terminals 2 of the plurality of battery cells 1, voltage detection lead wires 8 respectively electrically coupled to bus bars 3, and voltage detection circuit 9 configured to detect a voltage of each of battery cells 1 via lead wires 8.

### (Battery Cell 1)

Each of battery cells 1 is a prismatic battery where an external shape of a surface having a wider width, i.e., a main surface, is quadrangular, and its thickness is thinner than the width. Furthermore, each of battery cells 1 is a secondary battery with charging and discharging capability, i.e., a lithium ion secondary battery. However, in the battery system of the present invention, each of battery cells 1 is not limited to a prismatic battery, as well as is not limited to a lithium ion secondary battery. As each of battery cells 1, any other batteries which can be charged can also be used, such as a non-aqueous electrolyte secondary battery or a nickel-hydrogen battery cell other than the lithium ion secondary battery.

Each of battery cells 1 is configured such that exterior can 1a stores an electrode assembly formed by stacking positive and negative electrode plates, is filled with an electrolyte, and is sealed in an airtight manner. Exterior can 1a has a columnar shape having a closed bottom, where an upper opening part thereof is closed in an airtight manner by sealing plate 1b formed from a metal plate. Exterior can 1a is formed by deep-drawing a metal plate made of aluminum, an aluminum alloy, or the like. Sealing plate 1b is formed from a metal plate made of aluminum, an aluminum alloy, or the like as in the case of exterior can 1a. Sealing plate 1b is inserted into the opening part of exterior can 1a, and, by allowing a boundary between an outer periphery of sealing plate 1b and an inner periphery of exterior can 1a to be irradiated with a laser beam for laser welding, sealing plate 1b is fixed to exterior can 1a in an airtight manner.

### (Electrode Terminal 2)

In each of battery cells 1, sealing plate 1b serves as a top surface, and is referred to as terminal surface 1x. Positive and negative electrode terminals 2 are fixed at both ends of terminal surface 1x. Positive and negative electrode terminals 2 are, as illustrated in the partial enlarged view of FIG. 2, each fixed to sealing plate 1b via insulating material 18, and are respectively coupled to positive and negative electrode plates (not illustrated). In each of positive and negative electrode terminals 2, welding surface 2b is provided around projection part 2a. Welding surface 2b has a flat surface shape parallel to a surface of sealing plate 1b. Projection part 2a is provided at a center part of welding surface 2b. In each of electrode terminals 2 in FIG. 2, projection part 2a has a cylindrical shape. Here, the projecting part is not necessarily of the cylindrical shape, but may be of a polygonal column shape or an elliptic cylinder shape. If positioning of the bus bar by using terminal holes 4a of each of bus bars 3, described later, is not required, such a configuration may be applied that welding surface 2b is not provided with a projection part.

Each of positive and negative electrode terminals 2 is positioned and fixed to sealing plate 1b of each of battery cells 1 to allow the positive electrode and the negative electrode to be bilaterally symmetric. This allows, in a case where battery cells 1 are bilaterally inverted from and stacked with each other, and electrode terminals 2 at the positive electrode and the negative electrode adjacent to each other are coupled with each other with bus bars 3, battery cells 1 adjacent to each other to be coupled or connected in series.

### (Battery Stack 10)

The plurality of battery cells 1 are stacked to allow a thickness direction of each of battery cells 1 to align with a stacking direction to constitute battery stack 10. In battery stack 10, the plurality of battery cells 1 are stacked to allow terminal surfaces 1x each provided with positive and negative electrode terminals 2, i.e., sealing plates 1b in the drawings, to be flush each other. In the battery system illustrated in FIGS. 1 to 3, battery stack 10 is fixed with fixing parts 13 to fix the plurality of battery cells 1 in a stacked state. Fixing parts 13 include a pair of end plates 14 disposed on both end faces of stacked battery cells 1 and binding members 15 that fix stacked battery cells 1 in a pressurized state with both ends being fixed to end plates 14.

In battery stack 10, as illustrated in FIG. 2, insulating spacers 16 are provided and each pinched between each two of battery cells 1 stacked with each other. Insulating spacers 16 in FIG. 2 are made of an insulating material, such as resin, and each produced into a thin plate shape or sheet shape. Insulating spacers 16 illustrated in FIG. 2 each have a plate shape having a size substantially identical to a size of each of surfaces facing each other of respective battery cells 1. Insulating spacers 16 are each stacked between each adjacent two of battery cells 1 to insulate the each adjacent two of battery cells 1 from each other. As a spacer disposed between adjacent two of battery cells 1, such a spacer may be used that has a shape formed with a flow channel for allow cooling gas to flow between the adjacent two of battery cells 1 and the spacer. The surface of each of battery cells 1 may be coated with an insulating material. A shrink tube made of polyethylene terephthalate (PET) resin, for example, may be used to thermally weld a surface of an exterior can, excluding electrode portions, of a battery cell. In this case, insulating spacers 16 may be omitted.

Furthermore, in battery system 100 illustrated in FIG. 2, end plates 14 are respectively disposed on both end faces of battery stack 10 with end face spacers 17 interposed. End face spacers 17 are respectively disposed, as illustrated in FIG. 2, between battery stack 10 and end plates 14 to insulate end plates 14 from battery stack 10. End face spacers 17 are each made of an insulating material, such as resin, and each produced into a thin plate shape or sheet shape. End face spacers 17 illustrated in FIG. 2 each have a size and a shape to wholly cover the surfaces facing each other of prismatic battery cells 1, and are respectively stacked between end plates 14 and battery cells 1 disposed at both ends of battery stack 10.

In battery system 100 illustrated in FIG. 2, battery cells 1 adjacent to each other are bilaterally inverted from each other to allow positive and negative electrode terminals 2 to be laterally opposite to each other to stack twelve battery cells 1 to constitute battery stack 10. In battery system 100, positive and negative electrode terminals 2 of battery cells 1 adjacent to each other are connected with bus bars 3 made of metal to couple battery cells 1 in series. However, the present invention does not limit a number and a coupling state of battery cells 1 constituting battery stack 10. In the battery system according to the present invention, a number and a coupling state of battery cells constituting a battery stack can be variously changed. For example, in a battery system, a plurality of battery cells may be coupled in both series and parallel to increase an output voltage and an output current.

### (Bus Bar 3)

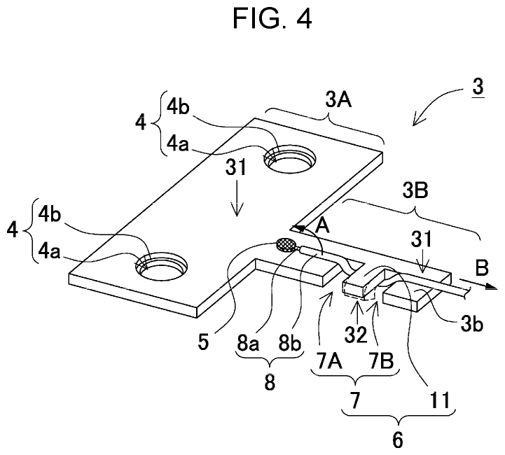

Bus bars 3 each couple with each other electrode terminals 2 of battery cells 1 facing and disposed adjacent to each other to couple the plurality of battery cells 1 in series. Bus bars 3 illustrated in FIGS. 1 to 3 are disposed facing an upper surface of battery stack 10, i.e., terminal surfaces 1x of battery cells 1 to couple, on both sides of battery stack 10, the plurality of electrode terminals 2 arranged in the stacking direction of the plurality of battery cells 1. Each of bus bars 3 include, as illustrated in FIGS. 4 to 6, bus bar main body 3A including a plurality of terminal coupling parts respectively coupled with electrode terminals 2, and lead wire fixing part 3B integrally connected to bus bar main body 3A and fixed with each of voltage detection lead wires 8.

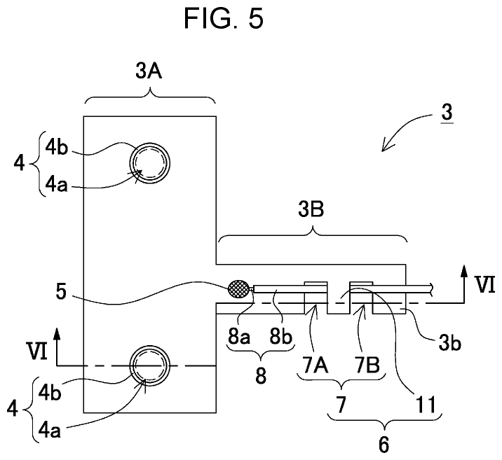

Bus bar main body 3A has a flat plate shape, as well as has, on both ends, terminal coupling parts 4 respectively configured to position and couple electrode terminals 2. Bus bar main body 3A illustrated in FIGS. 4 and 5 is provided with, as terminal coupling parts 4, terminal holes 4a that are open and that are each configured to guide and position projection part 2a of each of electrode terminals 2. Terminal holes 4a illustrated in the drawings are through holes each internally having an inner shape capable of accepting projection part 2a, and each having a circular shape along an external shape of projection part 2a having a cylindrical shape. Furthermore, in bus bar main body 3A, a gap between terminal holes 4a is made identical to a gap between electrode terminals 2 of battery cells 1 disposed at predetermined positions. This allows electrode terminals 2 of the plurality of battery cells 1 to be securely coupled with single one of bus bars 3. Although not illustrated, the terminal holes may be elongated holes capable of permitting a positional error between the electrode terminals to be coupled. If positioning of the bus bar is not required, such a configuration may be adopted that bus bar main body 3A is not provided with terminal holes 4a. In this case, the bus bar is welded while being overlapped on a welding surface of an electrode terminal having no projection part.

In the battery system in FIGS. 1 to 3, to couple in series, with each of bus bars 3, two battery cells 1 stacked adjacent to each other, two terminal holes 4a are provided on the both ends of bus bar main body 3A. The bus bar does not necessarily couple in series each two of battery cells 1. For example, a bus bar may couple in both series and parallel four battery cells. Such a bus bar is provided with four terminal holes 4a.

A material and a shape of bus bar main body 3A is determined to achieve electric resistance capable of allowing a current to flow into the plurality of battery cells 1 coupled in series. That is, as for each of bus bars 3, a maximum current to flow is taken into account to determine an optimum thickness and an optimum width for a metal plate to be formed into bus bar main body 3A. As for each of bus bars 3, a thickness and a lateral width of a metal plate to be formed into bus bar main body 3A respectively range from 1 mm to 3 mm inclusive, and from 1 cm to 3 cm inclusive.

The bus bar has a flat plate shape and is allowed to be stacked on and connected to upper surfaces of welding surfaces 2b of electrode terminals 2 of the plurality of battery cells 1 disposed on a single flat surface. Bus bars 3 are respectively laser-welded and coupled to electrode terminals 2 guided by terminal holes 4a of terminal coupling parts 4. A laser beam is adjusted to have energy allowing terminal coupling parts 4 of bus bars 3 to be securely welded onto welding surfaces 2b.

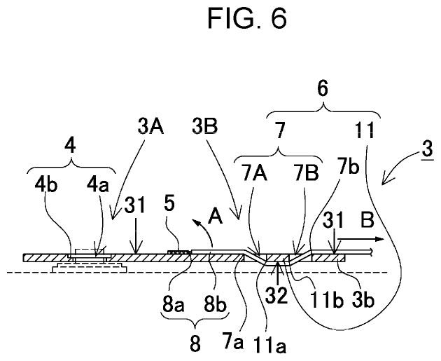

Terminal coupling parts 4 are provided, on peripheral parts of terminal holes 4a, respectively, with thin wall parts 4b each formed to be thinner than bus bar main body 3A for easy welding onto welding surfaces 2b. Thin wall parts 4b are, as illustrated in FIG. 6, each formed into a step shape cut out on an upper surface side at ends of each of bus bars 3. As described above, with the thin wall parts each having a shape obtained by cutting out the upper surface side at the ends of the bus bar, a lower surface side can come into contact, in a wider area, with the welding surface that is to be undergone welding, and laser light can pass through the thin wall part for secure welding.

Thin wall parts 4b each have a thickness allowing laser welding to be securely performed onto welding surface 2b of each of electrode terminals 2. The thickness of each of thin wall parts 4b corresponds to a size allowing welding surface 2b to be securely irradiated and welded with a laser beam, and is 0.3 mm or greater, and preferably 0.4 mm or greater, for example. If each of thin wall parts 4b is too thick, greater energy is required during laser-welding of each of terminal coupling parts 4 onto each of welding surfaces 2b. Therefore, the thickness of each of thin wall parts 4b is less than or equal to 2 mm, and preferably is less than or equal to 1.6 mm, for example.

As described above, when terminal coupling parts 4 where the peripheral parts of terminal holes 4a are formed thinner are respectively welded with electrode terminals 2, welding energy can be reduced. Therefore, a welding period can be shortened to achieve mass production at a lower cost, as well as heat input during the welding can be reduced to reduce negative effects to the battery cells. As for bus bar main body 3A, the thickness of each of thin wall parts 4b of terminal coupling parts 4 may range from 0.6 mm to 1.2 mm inclusive, and may preferably range from 0.7 mm to 1.0 mm inclusive.

Lead wire fixing part 3B is integrally connected to bus bar main body 3A, and is fixed with each of voltage detection lead wires 8 at a fixed position. Lead wire fixing part 3B illustrated in FIGS. 4 to 6 is a projection piece projecting from a center part of bus bar main body 3A. As for each of bus bars 3 illustrated in the drawings, lead wire fixing part 3B is connected to bus bar main body 3A, at a position shifted toward one of (forward in FIG. 4) terminal holes 4a from a center of bus bar main body 3A, i.e., from an intermediate point between the pair of terminal holes 4a, in a posture of projecting outward. However, in a bus bar, a projection piece may be provided to project outward from an intermediate point between a pair of terminal holes to serve as a lead wire fixing part. Lead wire fixing part 3B projecting from bus bar main body 3A has a band shape having a predetermined width, and is identical in thickness to the bus bar main body 3A.

Each of bus bars 3 includes, on first surface 31, coupling region 5 electrically coupled with each of lead wires 8 for fixing the each of lead wires 8 at a predetermined position on lead wire fixing part 3B, and, away from coupling region 5, on lead wire fixing part 3B, lock connection part 6 locking and connecting the each of lead wires 8.

Coupling region 5 serves as a region coupling a tip part of each of lead wires 8, and is provided on a front-side surface of each of bus bars 3, i.e., on first surface 31. In each of bus bars 3 illustrated in FIGS. 4 to 6, coupling region 5 lies at a rear end of lead wire fixing part 3B, around a boundary part with bus bar main body 3A. Coupling region 5 is fixed and electrically coupled with the tip part of the each of lead wires 8 through laser welding, for example. With the structure where coupling region 5 is provided at this position, heat input to each of battery cells 1 is reduced during welding of each of lead wires 8, reducing negative effects to the each of battery cells 1. However, the coupling region can be provided on the bus bar main body.

Lock connection part 6 has through part 7 passing through lead wire fixing part 3B for fixing each of lead wires 8 at a fixed position. Through part 7 passes through and is open from a front-side surface of lead wire fixing part 3B, i.e., first surface 31, to a rear-side surface opposite to first surface 31, i.e., second surface 32. When each of lead wires 8 is at least disposed from second surface 32 to first surface 31 of each of bus bars 3, lock connection part 6 fixes, in through part 7, the each of lead wires 8 at the fixed position.

Lock connection part 6 illustrated in FIGS. 4 to 6 is provided, as through part 7, with two columns of slit-shaped cutouts 7A, 7B. Lock connection part 6 illustrated in the drawings is provided with cutouts 7A, 7B each having a slit shape being open on one of side surfaces of lead wire fixing part 3B, as well as is formed with lock piece 11 between the two columns of cutouts 7A, 7B separated from each other. In lead wire fixing part 3B, a shape in a plan view of lock connection part 6, which is formed by the two columns of cutouts 7A, 7B and lock piece 11, is substantially an E-shape.

In lock connection part 6, as illustrated in FIG. 6, the each of lead wires 8 arranged from a tip side of lead wire fixing part 3B toward bus bar main body 3A is disposed to pass and extend from first surface 31 at tip part 3b of lead wire fixing part 3B, via second surface 32, to first surface 31 at the rear end of lead wire fixing part 3B. That is, the each of lead wires 8 is wired in order from first surface 31 at tip part 3b of lead wire fixing part 3B→cutout 7B→a rear-side surface of lock piece 11, i.e., second surface 32→cutout 7A→first surface 31 at the rear end of lead wire fixing part 3B→coupling region 5, and fixed to lead wire fixing part 3B. The each of lead wires 8 is fixed after the tip part is welded to coupling region 5, and an intermediate part is locked onto lock connection part 6.

As for each of lead wires 8, which is wired and fixed to lead wire fixing part 3B as described above, when the intermediate part is locked onto lock connection part 6, the each of lead wires 8 is prevented from moving in a direction in which a welded part welded to coupling region 5 is peeled off from each of bus bars 3, i.e., in a direction of separation from an upper surface of the each of bus bars 3 (direction indicated by arrow A in FIG. 6), as well as is prevented from moving in a pull-out direction, i.e., a pulling direction of the each of lead wires 8 (direction indicated by arrow B in FIG. 6). Even when pulled in the direction indicated by arrow B in FIG. 6, the each of lead wires 8, which is fixed to lead wire fixing part 3B, is locked at opening edge 7b representing a boundary between first surface 31 at tip part 3b of lead wire fixing part 3B and cutout 7B, opening edge 11b representing a boundary between the rear-side surface of lock piece 11, i.e., second surface 32, and cutout 7B, opening edge 11a representing a boundary between the rear-side surface of lock piece 11, i.e., second surface 32, and cutout 7A, and opening edge 7a representing a boundary between first surface 31 at the tip part of lead wire fixing part 3B and cutout 7A. Precisely, friction force acting on the each of lead wires 8, which abuts boundary edges 7a, 7b, 11a, and 11b, suppresses the each of lead wires 8 from moving in the direction, indicated by arrow B, of separation from bus bar 3. The friction force increases as force of pulling the each of lead wires 8 in the direction indicated by arrow B increases, resulting in that the each of lead wires 8 is fixed and prevented from coming off lead wire fixing part 3B.

Furthermore, in a case where, as illustrated in FIG. 4, a tip part of lock piece 11 is bent downward, as illustrated by a chain line in FIG. 4 while each of lead wires 8 is guided into the two columns of cutouts 7A, 7B, each of bus bars 3 can effectively prevent the each of lead wires 8 from coming off. This further fixes, to lead wire fixing part 3B, the each of lead wires 8, which is locked onto lock connection part 6, further preventing the each of lead wires 8 from coming off.

Bus bars 3 described above are each manufactured by cutting and processing a metal plate into a predetermined shape. That is, bus bars 3 are each manufactured into such a shape that lead wire connection part 3B is connected to bus bar main body 3A, terminal coupling parts 4 are formed on bus bar main body 3A, and further, the two columns of cutouts 7A, 7B are formed on lead wire connection part 3B. As a metal plate constituting each of bus bars 3, such a metal can be used that has small electric resistance and that is lighter in weight, such as aluminum and an aluminum alloy. However, as a metal plate used to form a bus bar, another metal or its alloy that has small electric resistance and that is lighter in weight may be used. In each of bus bars 3, which is made of a single metal, a sheet of metal plate is press-worked to integrally form, in a predetermined shape, bus bar main body 3A and lead wire connection part 6. Bus bars 3 each having the structure can be simply and easily mass-produced. Furthermore, the bus bar may be, as will be described later in detail, made of a clad material joining metals different in kind from each other.

### (Lead Wire 8)

Each of lead wires 8 includes core wire 8a having conductivity, and coating part 8b obtained by allowing core wire 8a to undergo insulating coating. For core wire 8a of each of lead wires 8, a copper wire may be used, for example. The core wire made from a copper wire may be a solid wire or a twisted wire made from a plurality of wires. In coating part 8b, a surface of core wire 8a is coated, for insulation, with resin such as vinyl, or rubber such as silicone rubber or fluorocarbon rubber. As described above, each of lead wires 8 including coating part 8b on its surface can be efficiently locked and fixed with greater friction force acting at lock connection part 6 of lead wire fixing part 3B.

Each of lead wires 8 has an end coupled to each of bus bars 3, and the other end coupled to voltage detection circuit 9 configured to detect a voltage of each of battery cells 1. On each of lead wires 8, core wire 8a is exposed from coating part 8b at the tip part, and the exposed part is electrically coupled to coupling region 5. Core wire 8a exposed at the tip of the each of lead wires 8 can be directly welded onto the coupling region through laser-welding. However, on the lead wire, the core wire exposed from the tip may be coupled with a coupling terminal (not illustrated), and this terminal may be fixed onto the coupling region through laser-welding, for example.

In the configuration described above, core wire 8a exposed at the tip of each of lead wires 8 is welded onto coupling region 5 of each of bus bars 3 through laser-welding. However, lead wires 8 and bus bars 3 may not be necessarily welded through laser-welding. In each of bus bars 3 configured as described above, the lead wire fixing part locks the lead wire, preventing a greater load from being applied onto a welded location of the lead wire and the bus bar. In particular, the lead wire locked by the lead wire fixing part is held at a certain tension at a portion extending from core wire 8a exposed at the tip of each of lead wires 8 to a location of lock by the lead wire fixing part. Therefore, the lead wire is free from effects of displacement on the portion between the location of lock by the lead wire fixing part and the end lying adjacent to the voltage detection circuit. This can prevent the welded location of the lead wire and the bus bar from being applied with repetitive stress, making it possible to reduce joining strength between the lead wire and the bus bar, compared with a conventional configuration. To join a lead wire and a bus bar, other various methods than laser-welding can be adopted.

### (Voltage Detection Circuit 9)

Voltage detection circuit 9 is, as illustrated in FIG. 3, coupled with lead wires 8 respectively coupled to bus bars 3, and, based on potential entered from each of lead wires 8, detects a voltage of each of battery cells 1.

When a voltage of each of battery cells 1 becomes greater or smaller than a set voltage set beforehand, voltage detection circuit 9 restricts or stops a current for charging and discharging of battery system 100 from flowing. For example, when a voltage of each of battery cells 1 being charged becomes greater than a maximum voltage, voltage detection circuit 7 restricts or stops a charge current, whereas, when a voltage of each of battery cells 1 being discharged becomes smaller than a minimum voltage, voltage detection circuit 7 restricts or stops a discharge current, to prevent over-charging or over-discharging from occurring in each of battery cells 1.

Other exemplary embodiments of the bus bar will be described herein in detail. In the exemplary embodiments described herein with reference to the drawings, the same reference marks denote the same configuration elements of the bus bar described above, and detailed description is therefore appropriately omitted.

### Second Exemplary Embodiment

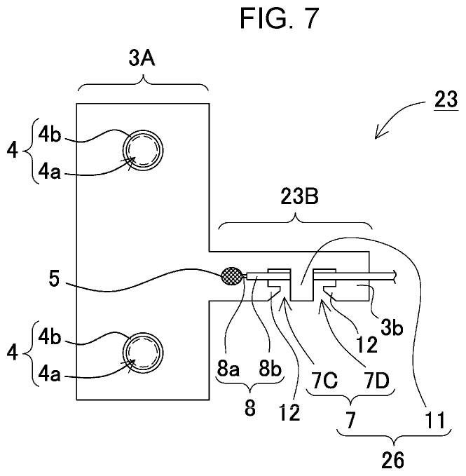

In bus bar 23 illustrated in FIG. 7, coupling region 5 coupling a tip part of lead wire 8 is provided on bus bar main body 3A. Therefore, in bus bar 23, projection amount T of lead wire connection part 23B projecting from bus bar main body 3A is reduced. This can reduce bus bar 23 in size.

Furthermore, in bus bar 23, on inner surfaces of opening parts of two columns of slit-shaped cutouts 7C, 7D formed as through part 7 on lock connection part 26, projections 12 projecting inward are integrally provided. Projections 12 formed at the portions can effectively prevent lead wire 8 guided by cutouts 7C, 7D from moving outward and from coming off cutouts 7C, 7D.

Projections 12 illustrated in FIG. 7 are each formed into a hook shape having an inclined surface, smoothly guiding lead wire 8 when inserted into cutouts 7C, 7D along the inclined surface.

### Third Exemplary Embodiment

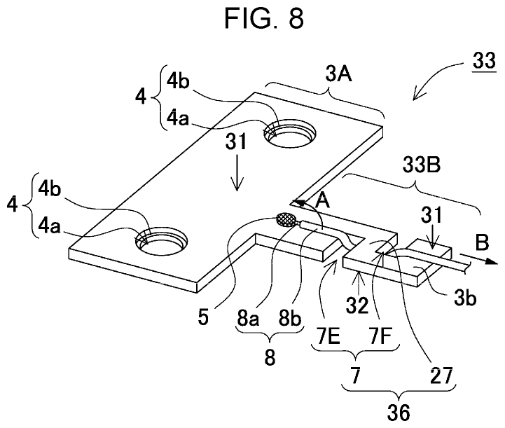

In bus bar 33 illustrated in FIG. 8, two columns of slit-shaped cutouts 7E, 7F are provided as through part 7 of lock connection part 36. However, different from lock connection part 6 illustrated in FIG. 4, cutouts 7E, 7F are respectively provided on sides opposite to each other of lead wire fixing part 33B. That is, in lead wire fixing part 33B illustrated in FIG. 8, cutout 7E formed adjacent to bus bar main body 3A is open on one of side surfaces (forward in FIG. 8) of lead wire fixing part 33B, whereas cutout 7F formed on a tip side of lead wire fixing part 33B is open on the other one of the side surfaces (rearward in FIG. 8) of lead wire fixing part 33B. Between the pair of cutouts 7E, 7F that are open in directions opposite to each other, intermediate connection part 27 is formed. In lead wire fixing part 33B, a shape in a plan view of lock connection part 36, which is formed by the two columns of cutouts 7E, 7F and intermediate connection part 27, is substantially an S-shape.

In lock connection part 36, as illustrated in FIG. 8, lead wire 8 wired from the tip side of lead wire fixing part 33B toward bus bar main body 3A is disposed to pass and extend from first surface 31 at tip part 3b of lead wire fixing part 33B, via a rear-side surface of intermediate connection part 27, i.e., second surface 32, to first surface 31 at a rear end of lead wire fixing part 33B. In bus bar 3 having the structure, when lead wire 8 fixed to lead wire fixing part 33B is locked onto lock connection part 36, lead wire 8 is prevented from moving in a direction in which a welded part welded to coupling region 5 is peeled off from bus bar 33 (direction indicated by arrow A in FIG. 8), as well as is prevented from moving in a pulling direction (direction indicated by arrow B in FIG. 8).

In particular, in bus bar 33 illustrated in FIG. 8, the pair of cutouts 7E, 7F being open on lead wire fixing part 33B are spaced away from each other in a direction of projection of lead wire fixing part 33B, and are open in directions different from each other, effectively preventing lead wire 8 guided by cutouts 7E, 7F from coming off the opening parts outward. Furthermore, although not illustrated, on inner surfaces of opening parts of the cutouts, projections for preventing a lead wire from coming off may be formed.

### Fourth Exemplary Embodiment

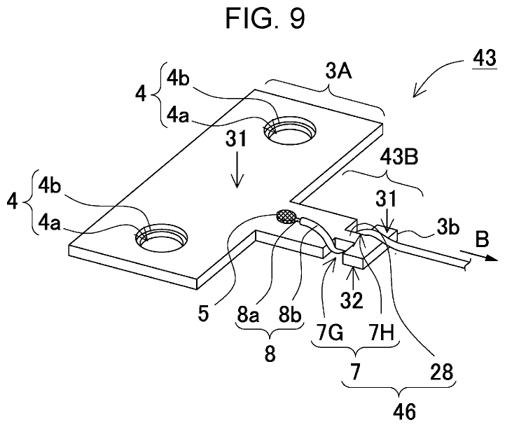

In bus bar 43 illustrated in FIG. 9, as through part 7 of lock connection part 46, two cutouts 7G, 7H being open in directions opposite to each other are provided at positions at distances substantially identical to each other from bus bar main body 3A. In bus bar 43, when two cutouts 7G, 7H are provided at positions at distances identical to each other from bus bar main body 3A, projection amount T of lead wire connection part 43B projecting from bus bar main body 3A can be reduced. This can reduce bus bar 43 in size.

Furthermore, between bottom surfaces of the pair of cutouts 7G, 7H, end connection part 28 connected to a tip part of lead wire fixing part 43B is formed. In lead wire fixing part 43B, a shape of lock connection part 46 in a plan view, which is formed by two cutouts 7G, 7H, end connection part 28, and the tip part of lead wire fixing part 43B, is a substantially T-shape. Although not illustrated, also in the lead wire fixing part, on inner surfaces of opening parts of the cutouts, projections for preventing a lead wire from coming off may be formed.

Also in lock connection part 46 having the structure, as illustrated in FIG. 9, lead wire 8 wired from the tip side of lead wire fixing part 43B toward bus bar main body 3A is disposed to pass through in order from first surface 31 at tip part 3b of lead wire fixing part 43B→cutout 7H→a rear-side surface of end connection part 28, i.e., second surface 32→cutout 7G→first surface 31 at a rear end of lead wire fixing part 3B. In bus bar 43 having the structure, even when lead wire 8 is pulled in a direction indicated by arrow B in FIG. 9, friction force acts between lead wire 8 and an opening edge representing a boundary between first surface 31 at the tip part of lead wire fixing part 43B and cutout 7H, an opening edge representing a boundary between the rear-side surface of end connection part 28, i.e., second surface 32, and cutout 7H, an opening edge representing a boundary between the rear-side surface of end connection part 28, i.e., second surface 32, and cutout 7G, and an opening edge representing a boundary between first surface 31 at the tip part of lead wire fixing part 43B and cutout 7G. As a result, lead wire 8 is prevented from moving in a direction of separation from bus bar 43 (direction indicated by arrow B in FIG. 9).

### Fifth Exemplary Embodiment

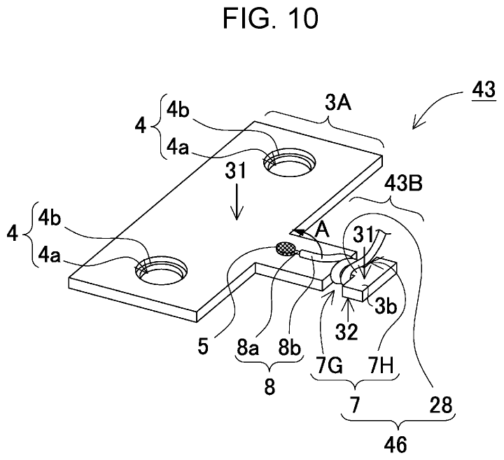

Furthermore, FIG. 10 illustrates another example of fixation of lead wire 8 to bus bar 43 illustrated in FIG. 9. In bus bar 43 illustrated in FIG. 10, lead wire 8 is wound onto end connection part 28 formed between two cutouts 7G, 7H. In the structure, friction force occurring in a contact portion between end connection part 28 and lead wire 8 wound onto end connection part 28 prevents lead wire 8 from moving in a direction of separation from bus bar 43. In the fixation structure, when lead wire 8 is wound onto end connection part 28 a plurality of times, lead wire 8 can be further securely fixed.

Furthermore, in the fixation structure, a pull-out direction of lead wire 8 fixed to lead wire fixing part 43B is not limited to the direction indicated by arrow B. A reason is that friction force occurring due to end connection part 28 being wound locks lead wire 8 onto lock connection part 46. Accordingly, in the structure, lead wire 8 can be pulled out in a desired direction. This can reduce restrictions on disposition of lead wire 8 on an upper surface of a battery stack.

### Sixth Exemplary Embodiment

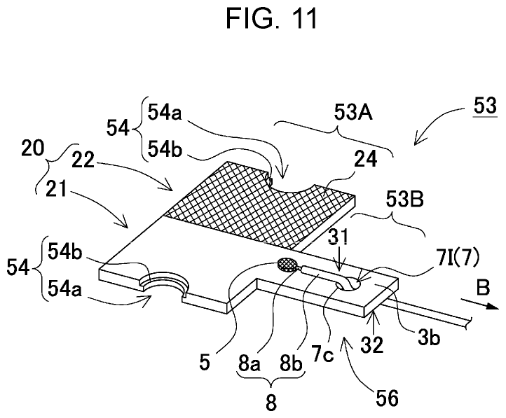

Furthermore, in bus bar 53 illustrated in FIG. 11, bus bar main body 53A is made from clad material 20 obtained by joining metals different in kind from each other. In clad material 20, first metal plate 21 and second metal plate 22 are press-fitted to join with each other. In bus bar 53, first metal plate 21 is made of a metal identical to the metal of the positive electrode terminal of the lithium ion battery serving as each of battery cells 1, i.e., made from an aluminum plate. Second metal plate 22 is made of a metal identical to the metal of the negative electrode terminal of the lithium ion battery serving as each of battery cells 1, i.e., made from a copper plate. In bus bar 53 made from clad material 20, first metal plate 21 is made from an aluminum plate, whereas second metal plate 22 is made from a metal plate different from the metal plate of first metal plate 21. That is, such a metal plate that can be coupled to electrode terminal 2 of battery cell 1 in an ideal state is selected. Accordingly, second metal plate 22 is not necessarily limited to a copper plate. Such a metal plate that can be coupled to electrode terminal 2 of battery cell 1 is used.

A surface of the aluminum plate of first metal plate 21 is coated with aluminum oxide, thereby preventing the surface from corroding. The aluminum plate can be irradiated with a laser light beam in a preferable state to undergo laser welding. With the configuration, no other plated layer is required on the surface of first metal plate 21 made from the aluminum plate. However, a surface of second metal plate 22 made from a plate other than an aluminum plate is provided with plated layer 24, thereby preventing the surface from corroding. The surface as well can prevent a laser light beam from reflecting, achieving efficient welding. Accordingly, plated layer 24 is provided on the surface of second metal plate 22. For plated layer 24, nickel plating is used. Nickel plating can prevent the surface of second metal plate 22 from corroding, as well as can prevent a laser light beam from reflecting, achieving secure laser welding. However, plated layer 24 of second metal plate 22 does not necessarily undergo nickel plating, but may undergo plating with another metal capable of preventing the surface from corroding, as well as of undergoing laser welding or soldering, for example.

Furthermore, in bus bar 53 illustrated in FIG. 11, terminal coupling parts 54 provided on both ends of bus bar main body 53A serve as cutout parts 54a respectively having arc shapes extending along outer peripheries of electrode terminals 2. Bus bar 53 illustrated in FIG. 11 is provided, at center parts on both end edges of bus bar main body 53A, with cutout parts 54a respectively having substantially semicircular shapes extending along projection parts 2a of the cylindrical shapes of electrode terminals 2. Furthermore, on terminal coupling parts 54 provided on the both ends of bus bar main body 53A, i.e., on peripheral parts of cutout parts 54a respectively having the substantially semicircular shapes, thin wall parts 54b each formed thinner than bus bar main body 53A are provided. Thin wall parts 54b each have a thickness allowing laser welding to be securely performed on welding surface 2b of each of electrode terminals 2. The thickness of each of thin wall parts 54b is designed to have a size allowing welding surface 2b to be securely welded with a laser beam irradiated to the surface for welding.

As described above, in bus bar 53 made from clad material 20 of first metal plate 21 and second metal plate 22, lead wire fixing part 53B is integrally formed with first metal plate 21 made from the aluminum plate. This can achieve reductions in both manufacturing cost and weight for bus bar 53.

Furthermore, in bus bar 53 illustrated in FIG. 11, through hole 7I is open as through part 7 of lock connection part 56. In lock connection part 56 illustrated in FIG. 11, lead wire 8 wired from a tip side of lead wire fixing part 53B toward bus bar main body 53A is disposed to pass and extend from a rear surface side of tip part 3b of lead wire fixing part 53B, i.e., second surface 32, via through hole 7I, to first surface 31 at a rear end of lead wire fixing part 3B. In bus bar 53, even when lead wire 8 is pulled in the direction indicated by arrow B in FIG. 11, lead wire 8 is locked due to friction force acting on lead wire 8 at an opening edge representing a boundary between second surface 32 at tip part 3b of lead wire fixing part 53B and through hole 7I, and opening edge 7c representing a boundary between first surface 31 at the rear end of lead wire fixing part 53B and through hole 7I.

### Seventh Exemplary Embodiment

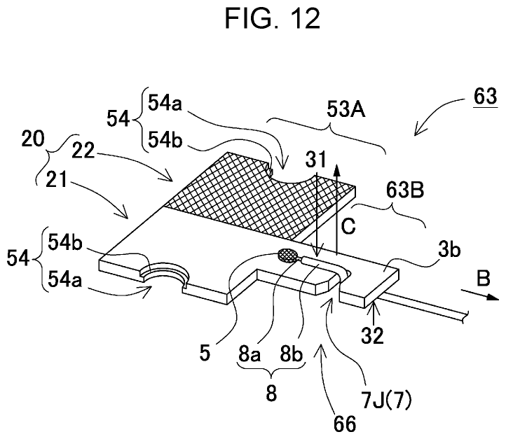

Furthermore, in bus bar 63 illustrated in FIG. 12, similar to bus bar 53 illustrated in FIG. 11 and described above, bus bar main body 53A is made from clad material 20 obtained by joining metals different in kind from each other, and terminal coupling parts 54 provided at both ends of bus bar main body 53A serve as cutout parts 54a respectively having arc shapes extending along the outer peripheries of electrode terminals 2. Furthermore, in bus bar 63, lead wire fixing part 63B has cutout 7J having a slit shape being open to serve as through part 7 of lock connection part 66. Lock connection part 66 illustrated in FIG. 12 is provided with one column of slit-shaped cutout 7J being open on one of side surfaces of lead wire fixing part 63B, and can hold, with cutout 7J at a fixed position, lead wire 8 inserted into cutout 7J. At cutout 7J illustrated in FIG. 12, its opening width gradually narrows in a depth direction. At a deepest part of cutout 7J, its opening width is designed to be capable of holding lead wire 8 in a press-fitted state. Furthermore, cutout 7J illustrated in FIG. 12 has an opening edge part formed into a tapered shape for ease of insertion of lead wire 8 to be inserted from this part.

In lock connection part 66, lead wire 8 wired from a tip side of lead wire fixing part 63B toward bus bar main body 53A is disposed to pass and extend from a rear surface side of tip part 3b of lead wire fixing part 63B, i.e., second surface 32, via cutout 7J, to first surface 31 at a rear end of lead wire fixing part 3B. In bus bar 63, when lead wire 8 is press-fitted into cutout 7J, friction between an inner surface of cutout 7J and a surface of lead wire 8 securely locks lead wire 8 onto lock connection part 66. In bus bar 63 illustrated in FIG. 12, lead wire 8 is pulled out in a direction indicated by arrow B. However, a lead wire can be pulled out within a range defined by the direction indicated by arrow B and a direction indicated by arrow C.

### Seventh Exemplary Embodiment

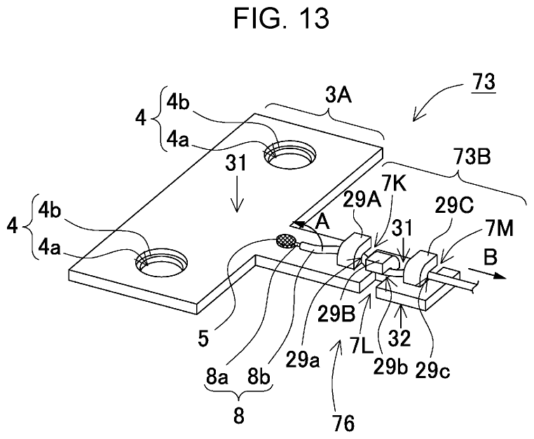

The bus bars described above each have the structure where, in the lead wire fixing part, the lead wire is allowed to pass through the through part to wire the lead wire at least from the second surface to the first surface of each of the bus bars. However, in each of the bus bars, as illustrated in FIGS. 13 to 15, in a vertical cross-sectional view, a lead wire can be wired in a posture where the lead wire is not allowed to meander in upper and lower directions, but is allowed to meander in a plan view.

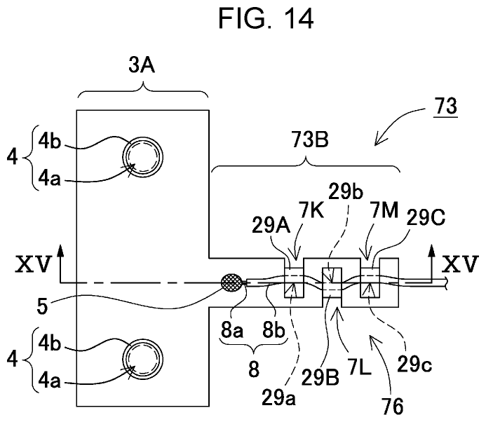

In the bus bar illustrated in FIGS. 13 to 15, three columns of slit-shaped cutouts 7K, 7L, and 7M are provided as through part 7 of lock connection part 76, as well as lock pieces 29A, 29B, and 29C respectively partially separated from lead wire fixing part 73B by cutouts 7K, 7L, and 7M are allowed to project on first surface 31 of lead wire fixing part 73B. Lock pieces 29A, 29B, and 29C projecting on first surface 31 of lead wire fixing part 73B allow groove parts capable of guiding lead wire 8 to be open in both side directions of lead wire fixing part 73B. Lock connection part 77 illustrated in the drawings is provided with the three columns of cutouts 7K, 7L, and 7M to allow three lock pieces 29A, 29B, and 29C to project on first surface 31 of lead wire fixing part 73B. In lock connection part 76 illustrated in the drawings, the three columns of cutouts 7K, 7L, and 7M are provided to alternately face in directions opposite to each other, as well as three lock pieces 29A, 29B, and 29C are respectively bent in directions opposite to each other to allow groove parts 29a, 29b, and 29c to alternately face in directions opposite to each other. In lock connection part 76, as illustrated in FIG. 14, in a plan view, while lead wire 8 is guided into groove parts 29a, 29b, and 29c of lock pieces 29A, 29B, and 29C respectively facing in directions opposite to each other, lead wire 8 is wired from a tip side of lead wire fixing part 73B toward bus bar main body 3A.

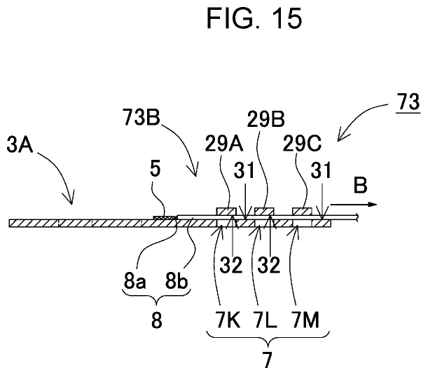

In bus bar 73 having the structure, as illustrated in FIG. 15, lead wire 8 is wired between a front-side surface of lead wire fixing part 73B, i.e., first surface 31, and rear-side surfaces, i.e., second surfaces 32, of lock pieces 29A, 29B, and 29C projected and bent on first surface 31. Furthermore, as illustrated in FIG. 14, also in a plan view, such a feature is achieved that a lead wire alternately locked on left and right sides by lock pieces 29A, 29B, and 29C arranged continuously can be securely fixed to withstand against tensile force in a direction indicated by arrow B. In lead wire fixing part 73B, lead wire 8 is locked in a direction from a tip toward a rear end direction of lead wire fixing part 73B by friction force at contact parts between lead wire 8 and inner side surfaces of lock pieces 29A, 29B, and 29C.

The bus bars according to the first to seventh exemplary embodiments described above are each illustrated in a state where the bus bar main body having the flat plate shape and the lead wire fixing part are disposed on a substantially single flat surface. Bus bars each having the structure representing a most simple structure can be mass-produced at a lower cost. However, a bus bar may be, although not illustrated, disposed in a posture where a lead wire fixing part is inclined with respect to a bus bar main body disposed in a posture parallel to an upper surface of a battery stack. The bus bar having the structure can be disposed while taking into account restrictions on disposition of members on the upper surface of the battery stack.

### Eighth Exemplary Embodiment

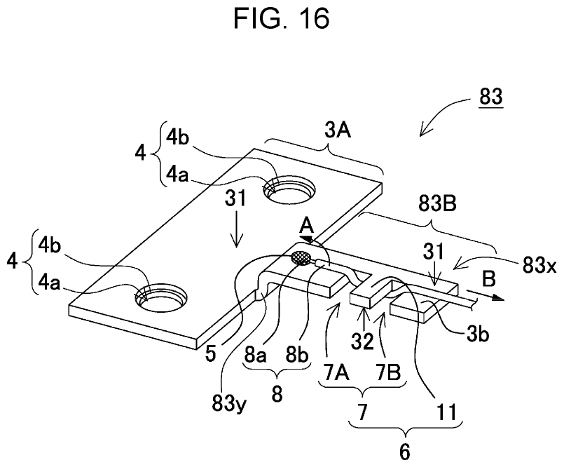

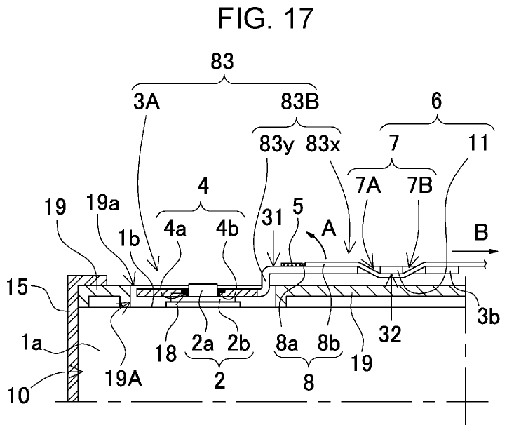

Furthermore, in bus bar 83 illustrated in FIGS. 16 and 17, with respect to bus bar main body 3A disposed in a posture parallel to an upper surface of a battery stack, lead wire fixing part 83B can be bent into a substantially Z-shape in a cross-sectional view to be in a posture parallel to bus bar main body 3A, as well as lead wire fixing part 83B can be disposed at a position one-step higher than bus bar main body 3A. In bus bar 83 illustrated in FIG. 16, at a boundary portion between bus bar main body 3A and lead wire fixing part 83B, erection part 83y obtained by bending lead wire fixing part 83B in a raised posture is provided, as well as, at an upper end of erection part 83y, main body part 83x of lead wire fixing part 83B is bent into a horizontal posture to dispose main body part 83x of lead wire fixing part 83B parallel to bus bar main body 3A. As illustrated in FIG. 17, bus bar 83 having the structure can be efficiently disposed on the upper surface of battery stack 10 in, for example, a battery system having a structure including surface plate 19.

In the battery systems illustrated in FIGS. 1 to 15, for ease of understanding of a coupling state between a battery cell and a bus bar, a surface plate disposed with a plurality of bus bars at fixed positions is omitted. In a battery system, when a surface plate is disposed on an upper surface of a battery stack, and through parts provided on the surface plate are used as holder parts for bus bars to dispose the bus bars, while the plurality of bus bars are insulated from each other, as well as terminal surfaces of battery cells and the bus bars are insulated from each other, the bus bars can be disposed at fixed positions on the upper surface of the battery stack. Such a surface plate may have a shape where, for example, a plurality of holder parts to be disposed with a plurality of bus bars are open. On such a surface plate made of an insulating material, such as a plastic material, where a plurality of bus bars are respectively disposed on holder parts, for example, while an area between electrode terminals, where a potential difference is present, is insulated, the plurality of bus bars can be disposed at fixed positions on an upper surface of a battery stack.

### (Surface Plate)

In the battery system illustrated in FIG. 17, surface plate 19 is disposed on the upper surface of battery stack 10, and surface plate 19 covers terminal surfaces 1X of battery cells 1 stacked with each other. Surface plate 19 is formed to have an external shape along the upper surface of battery stack 10. Surface plate 19 is made of an insulative plastic material such as a nylon resin and an epoxy resin. Furthermore, surface plate 19 is, as illustrated in FIG. 17, provided with holder part 19A configured to allow electrode terminals 2 of battery cells 1 to expose and dispose bus bar 83. Holder part 19A is open upward to serve as opening window 19a. On surface plate 19, although not illustrated, a plurality of holder parts 19A can be provided along both side parts of battery stack 10. Holder part 19A has a size and a shape conforming to an external shape of bus bar 3 to allow bus bar 3 to be guided to a fixed position and to be coupled to electrode terminals 2. Bus bar 3 disposed on holder part 19A of surface plate 19 is fixed to electrode terminals 2 of battery cells 1 through welding, such as laser welding, to couple the plurality of battery cells 1 in a predetermined coupling state.

As illustrated in FIG. 17, bus bar 83 illustrated in FIG. 16 has a structure allowing bus bar main body 3A to be disposed on holder part 19A of surface plate 19, as well as allowing lead wire fixing part 83B to be disposed on an upper surface side of surface plate 19. In bus bar 83 having the structure, bus bar main body 3A can be disposed on holder part 19A being open on surface plate 19, i.e., to be disposed at a fixed position of each of electrode terminals 2, as well as lead wire fixing part 83B projecting from bus bar main body 3A can be disposed on an upper surface of surface plate 19. This reduces restrictions on disposition of lead wire fixing part 83B.

The battery system described above can be utilized as an on-vehicle power source. Examples of a vehicle having a battery system mounted include electric vehicles such as hybrid vehicles or plug-in hybrid vehicles driven by both an engine and a motor, and electric-motor driven automobiles such as electric automobiles only driven by a motor. The battery system can be used for power sources of these vehicles. Battery system 1000 will now be described herein as a construction example of a high capacity, high output battery system where a plurality of battery systems described above are coupled in series or parallel to obtain power used to drive a vehicle, and a required controlling circuit is further added.

### (Battery System for Hybrid Vehicle)

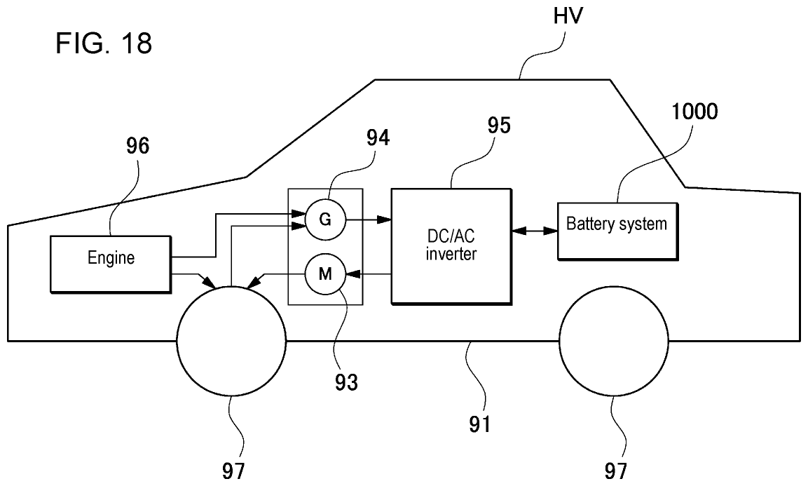

FIG. 18 shows an example in which a battery system is mounted on a hybrid vehicle driven by both an engine and a motor. Vehicle HV mounted with the battery system illustrated in FIG. 18 includes vehicle main body 91, engine 96 and traction motor 93 used to allow vehicle main body 91 to travel, wheels 97 driven by engine 96 and traction motor 93, battery system 1000 configured to supply power to motor 93, and generator 94 configured to charge a battery of battery system 1000. Battery system 1000 is connected to motor 93 and power generator 94 via DC/AC inverter 95. Vehicle HV travels by both of motor 93 and engine 96 while charging or discharging the battery of battery system 1000. Motor 93 is driven when the engine efficiency is low, for example, during acceleration or low-speed travel, and makes the vehicle travel. Motor 93 receives power from battery system 1000 and is driven. Power generator 94 is driven by engine 96 or is driven by regenerative braking when the vehicle is braked, and therefore the battery of battery system 1000 is charged.

### (Battery System for Electric Vehicle)

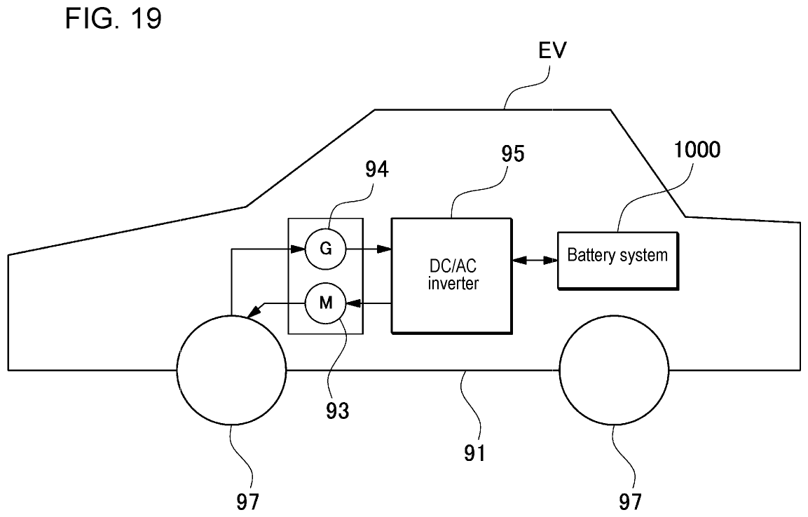

FIG. 19 shows an example in which a battery system is mounted on an electric car traveling only by a motor. Vehicle EV mounted with the battery system illustrated in FIG. 19 includes vehicle main body 91, traction motor 93 allowing vehicle main body 91 to travel, wheels 97 driven by motor 93, battery system 1000 configured to supply power to motor 93, and generator 94 configured to charge a battery of battery system 1000. Battery system 100 is connected to motor 93 and power generator 94 via DC/AC inverter 95. Motor 93 receives power from battery system 1000 and is driven. Power generator 94 is driven by energy when regenerative braking is applied to vehicle EV, and the battery of battery system 1000 is charged.

### (Power Storage System)

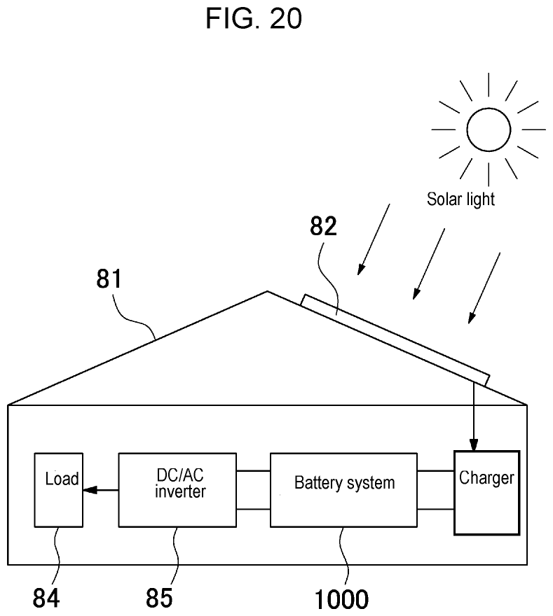

Furthermore, the present invention does not limit applications of the battery system to only a power source of a motor used to allow a vehicle to travel. The battery system according to the present invention can be used as a power source of a power storage system configured to charge a battery with power generated through photovoltaic power generation or wind power generation, for example to store the power. FIG. 20 illustrates a power storage system configured to use solar cells to charge a battery of battery system 1000 to store power. The power storage system illustrated in FIG. 20 charges, as illustrated in FIG. 20, for example, the battery of battery system 100 with power generated by solar cells 82 disposed on a roof or a roof floor of building 81, such as a house or a factory. Furthermore, the power storage system supplies power stored in battery system 100 to load 83 via DC/AC inverter 85.

Furthermore, although not illustrated, the battery system can be used as a power source of a power storage system configured to utilize night power available during nighttime to charge a battery to store the power. A battery system configured to be charged with night power can use excess power, i.e., night power, of a power station to perform charging, can output the power during daytime when power loads increase, and can restrict peak power during daytime to be smaller. Furthermore, the battery system can be used as a power source configured to be charged with both an output of solar cells and night power. The battery system can effectively utilize both power generated by solar cells and night power to efficiently store power while taking into account weather conditions and power consumption.

The power storage system described above can be advantageously utilized in various applications, such as a backup battery system mountable on a rack for a computer server, a backup battery system for a wireless base station for cellular phones, a power storage device combined with solar cells such as a power source configured to store power for a household or factory purpose and a power source for street lights, and a backup power source for road traffic lights and road traffic indicators.

### INDUSTRIAL APPLICABILITY

The battery device according to the present invention is optimally used for a vehicular battery system that supplies power to a motor of a vehicle that requires large power or a power storage device that stores natural energy or night power.

### REFERENCE MARKS IN THE DRAWINGS

100, 1000: battery system
1: battery cell
1X: terminal surface
1a: exterior can
1b: sealing plate
2: electrode terminal
2a: projection part
2b: welding surface
3, 23, 33, 43, 53, 63, 73, 83: bus bar
3A, 53A: bus bar main body
3B, 23B, 33B, 43B, 53B, 63B, 73B, 83B: lead wire fixing part
3b: tip part
83x: main body part
83y: erection part
4a, 54a: terminal hole
4b, 54b: thin wall part
5: coupling region
6, 26, 36, 46, 56, 66, 76: lock connection part
7: through part
7A, 7B, 7C, 7D, 7E, 7F, 7G, 7H, 7J, 7K, 7L, 7M: cutout
7I: through hole
7a, 7b, 7c: boundary edge
8: lead wire
8a: core wire
8b: coating part
9: voltage detection circuit
10: battery stack
11: lock piece
11a, 11b: boundary edge
12: projection
13: fixing part
14: end plate
15: binding member
16: insulating spacer
17: end face spacer
18: insulating material
19: surface plate
19A: holder part
19a: opening window
20: clad material
21: first metal plate
22: second metal plate
24: plated layer
27: intermediate connection part
28: end connection part
29A, 29B, 29C: lock piece
29a, 29b, 29c: groove part
31: first surface
32: second surface
81: building
82: solar cell
84: load
85: DC/AC inverter
91: vehicle main body
93: motor
94: generator
95: DC/AC inverter
96: engine
97: wheel
102: electrode terminal
103: bus bar
104: voltage detection terminal
108: lead wire
HV: vehicle
EV: vehicle

1. A battery system comprising:
a battery stack formed by stacking a plurality of battery cells each including positive and negative electrode terminals;
a bus bar coupling with each other the electrode terminals of the plurality of battery cells;
a lead wire used for voltage detection and electrically coupled to the bus bar; and
a voltage detection circuit configured to detect a voltage of each of the battery cells via the lead wire,
wherein
the bus bar includes
a bus bar main body including a plurality of terminal coupling parts respectively coupled with the electrode terminals, and
a lead wire fixing part integrally connected to the bus bar main body, the lead wire fixing part being fixed with the lead wire,
the bus bar further includes, on a first surface, a coupling region electrically coupled with the lead wire, and, away from the coupling region, on the lead wire fixing part, a lock connection part locking and connecting the lead wire,
the lock connection part includes a through part passing through the lead wire fixing part, and
in the through part, the lead wire is disposed at least from a second surface opposite to the first surface to the first surface of the bus bar.

2. The battery system according to claim 1, wherein the through part includes a cutout obtained by cutting out a part of the lead wire fixing part.

3. The battery system according to claim 2, wherein the through part is a plurality of the cutouts each having a slit shape, formed into a plurality of columns.

4. The battery system according to claim 3, wherein the plurality of the cutouts each having the slit shape, formed into the plurality of columns, are provided on side surfaces facing each other of the lead wire fixing part.

5. The battery system according to claim 2, wherein the through part has a projection projecting to reduce an opening area of the cutout.

6. The battery system according to claim 1, wherein
the bus bar main body has a flat plate shape, and
the lead wire fixing part is a projection piece projecting from the bus bar main body.

7. The battery system according to claim 1, wherein
the lead wire includes
a core wire having conductivity, and
a coating part obtained by allowing the core wire to undergo insulating coating, and
the lead wire is locked onto the lock connection part via the coating part.

8. The battery system according to claim 1, wherein the bus bar main body and the lead wire are made of metals different in kind from each other.

9. The battery system according to claim 1, wherein the bus bar main body is made of aluminum.

10. The battery system according to claim 1, wherein the coupling region serves as a region coupled with, through welding, the lead wire made of copper.

11. A bus bar for electrically coupling with each other electrode terminals of battery cells, the bus bar comprising:
a bus bar main body including a plurality of terminal coupling parts configured to be coupled with the electrode terminals; and
a lead wire fixing part integrally connected to the bus bar main body, the lead wire fixing part being configured to be fixed with a lead wire used for voltage detection,
wherein
the bus bar further includes, on a first surface, a coupling region configured to be electrically coupled with the lead wire, and, away from the coupling region, on the lead wire fixing part, a lock connection part configured to lock and connect the lead wire, and
in the lock connection part, a through part capable of disposing the lead wire from a second surface opposite to the first surface to the first surface of the bus bar is provided to pass through the lead wire fixing part.
